(19) United States
(12) Patent Application Publication
(10) Pub. No.: US 2017/0136380 A1
(43) Pub. Date: May 18, 2017

(54) Smart Toys

(71) Applicant: Matthew Creedican, Arlington, WA (US)

(72) Inventor: Matthew Creedican, Arlington, WA (US)

(21) Appl. No.: 14/945,414

(22) Filed: Nov. 18, 2015

(51) Int. Cl. A63H 33/04; A63H 33/06

(52) U.S. Cl. CPC A63H 33/042; A63H 33/06; A63H 33/048; A63H 2200/00; H04W 92/10

(57) ABSTRACT

Smart toys may comprise toy blocks or other shapes which may communicate electronically with one another and provide information regarding the toys or how they relate. For example, a user may arrange letter or number blocks to form words or mathematical equations, and smart toys may recite the resulting word or answer through a built-in speaker. Smart toys may contain internal electronics which allow the smart toys to operate and communicate with one another without the need for additional devices such as a mat or board, for example.

### FIELD

This disclosure relates generally to smart toys.

### BACKGROUND

Toys may serve as both recreational and learning tools for children and adults. Many conventional toys are limited in scope in terms of the skills they teach and the recreational opportunities they offer.

### SUMMARY

The instant application discloses, among other things, smart toys, which may be toy pieces configured to communicate with one another electronically to give a user an interactive or personalized experience. Smart toys may be toy blocks or other shapes which may provide visual, audio, or other information regarding the toys or how they relate. A user may place alphabet blocks adjacent to one another to form a word, for example, and smart toys may determine the placement of the blocks and recite the resulting word through a built-in speaker.

Smart toys may contain built-in electronics which may allow the toys to operate and communicate with one another without the need for auxiliary devices such as a mat or board. According to one embodiment, smart toys may include a toy containing a central processing unit (CPU), and a peripheral toy which may communicate electronically with the control toy. Smart toys may have Radio-Frequency Identification (RFID), Wi-Fi, Bluetooth, or Near-Field Communication (NFC) capabilities, for example.

### BRIEF DESCRIPTION OF THE DRAWINGS

FIG. 1 illustrates smart toys, according to one embodiment.

FIG. 2 illustrates smart toys, according to another embodiment.

FIG. 3 illustrates smart toys, according to another embodiment.

FIG. 4 illustrates a smart toys process, according to one embodiment.

FIG. 5 is a block diagram illustrating an example of a system capable of supporting smart toys, according to one embodiment.

FIG. 6 is a block diagram illustrating an example of a system capable of supporting smart toys, according to one embodiment.

FIG. 7 illustrates smart toys, according to another embodiment.

FIG. 8 illustrates smart toys, according to another embodiment.

FIG. 9 illustrates smart toys, according to another embodiment.

FIG. 10 is a component diagram of a computing device to which a smart toys process may be applied according to one embodiment.

Like reference numerals are used to designate like parts in the accompanying drawings.

### DETAILED DESCRIPTION

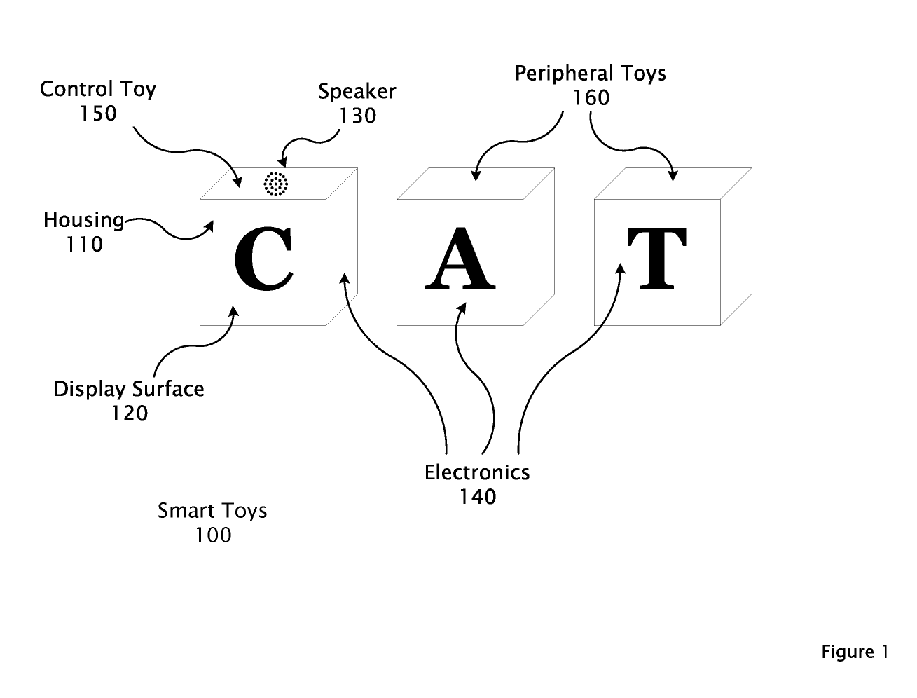

FIG. 1 illustrates Smart Toys 100, according to one embodiment. Smart Toys 100 may comprise toy blocks or other shapes configured to communicate electronically with one another and provide visual, audio, or other information regarding the toys or how they relate. Smart Toys 100 may have a Housing 110, which may have any size and shape, for example, a cube, cuboid, pyramid, sphere, or disc. Housing 110 may be made of plastic, rubber, wood, carbon fiber, fiberglass, or any other material. Smart Toys 100 may have a Display Surface 120, for example, an LED screen or touch screen, which may display letters, numbers, symbols, photos, or other graphics. Display Surface 120 may also be a static display, a letter painted on a block, for example. Smart Toys may emit sounds through a built-in Speaker 130. Speaker 130 may be disposed within Housing 110, or may be exposed on a surface.

Smart Toys 100 may contain built-in Electronics 140, which may allow the toys to operate and communicate with one another or with other devices. Smart Toys 100 may also be configured to respond to stimuli such as light or sound. In one embodiment, Smart Toys 100 may be programmed, either individually or in sets, to each produce different sounds or displays to create a distributed interactive system. For example, each toy may light up in response to sound waves, and a user may visualize the speed of sound as each toy lights up. In another embodiment, the user may play a sound on each toy using time delay to show how beam forming works.

Smart Toys 100 may have a Control Toy 150, which may contain a central processing unit (CPU). Control Toy 150 may carry out instructions of a computer software program, for example. Smart Toys 100 may include one or more Peripheral Toys 160 which may communicate with, input data into, or output data from Control Toy 150. Control Toy 150 and Peripheral Toys 160 may also contain, for example, transceivers, readers, chips, coils, sensors, and other Electronics 140. Sensors may include accelerometers, proximity sensors, motion sensors, pressure sensors, biometric sensors, audio sensors, barcode, or QR code scanners, for example. Smart Toys 100 may have Radio-Frequency Identification (RFID), Wi-Fi, Bluetooth, or Near-Field Communication (NFC) capabilities, or any other method of interfacing with a device or gaining access to the Internet for programming and customization, for example. In another embodiment, each Smart Toy may have a CPU and may be capable of operating independently of other Smart Toys.

In this example, Smart Toys 100 may comprise alphabetic blocks which a user may place adjacent to one another to form a word. Smart Toys 100 may communicate with one another electronically to determine the placement of the blocks and recite the resulting word through Speaker 130. Smart Toys 100 may also spell out words by naming letters on each block, or it may recite letters or letter groups phonetically to teach letter sounds or reading skills.

In another embodiment, Smart Toys 100 may comprise colored discs or other shapes. When the user places the toys in close proximity to one another, a blended version of the colors may appear on an original to or a separate toy, for example. Smart Toys 100 may include RFID, radar, lidar, sonar, or ultrasound, for example, to determine proximity to objects or people, or to identify nearby toys. Smart Toys 100 may also detect the orientation of a toy; for example, if a toy has different colors on different sides, it may recite which side was facing up.

In another embodiment, Smart Toys 100 may comprise shapes which the user may stack or combine to learn the weight, height, volume, quantity, structural integrity, or other attributes of the toys. Smart Toys 100 may provide information in various units of measurement, for example, to teach metric conversion. In another embodiment, the user may place Smart Toys 100 apart, and the toys may communicate electronically to determine the distance between the two toys and recite or display that distance. This may be helpful in taking measurements in environments wherein a conventional tape measure or laser distance measure may be unsuitable.

In yet another embodiment, Smart Toys 100 may comprise shapes, for example, cuboids, which may be used in a stacking game where users try to keep a structure from falling. The user may create personalized graphics which may be displayed on Display Surface 120 of one or more Smart Toys 100 or create personalized sounds which may be emitted through Speaker 130. In yet another embodiment, Smart Toys 100 may comprise interlocking building toys which the user may combine to create an interactive or personalized toy. The user may combine Smart Toys 100 to form a structure, such as a tower or airplane, for example. The user may also use Smart Toys 100 to create personas or other unique and characteristics for Smart Toys 100 or other toys. For example, the user may place a Smart Toy 100 military helmet on an existing human toy piece, and Smart Toy 100 may speak in a sergeant voice or another voice created by the user. Smart Toys 100 may be configured to function with other Smart Toys 100 or other toys and devices, for example, action figures, dolls, or interlocking building toys.

In yet another embodiment, Smart Toys 100 may comprise toy dice which the user may roll in order to receive an audio notification of the total number of dots facing up, for example. This may be helpful for vision-impaired users. Smart Toys 100 may also allow vision-impaired users to play a game of chess or checkers, for example, without the need of a board or mat, as they may receive audio notifications of the opponents' moves. In yet another embodiment, Smart Toys 100 may display musical notes and allow the user to place the musical notes in various arrangements to compose melodies or songs. In addition to visual and audio information, Smart Toys 100 may provide tactile information; for example, it may be configured to produce textured notifications in Braille or another writing system, or to emit vibrations or various levels of heat, cold, moisture, smells, for example. Smart Toys 100 may also be configured to translate and provide information in different languages, for example.

Smart Toys 100 also may receive input from the user to be used at another time. For example, the toy may record a user's voice and repeat it back at a later time. In another example, the user may shake Smart Toys 100 three times, and the toy may display the number “3.” In yet another example, the user may use the toy to draw a pattern, for example, the letter “A,” and the toy may display the drawn shape. The user may also program a toy by touching them to a touch screen icon, for example.

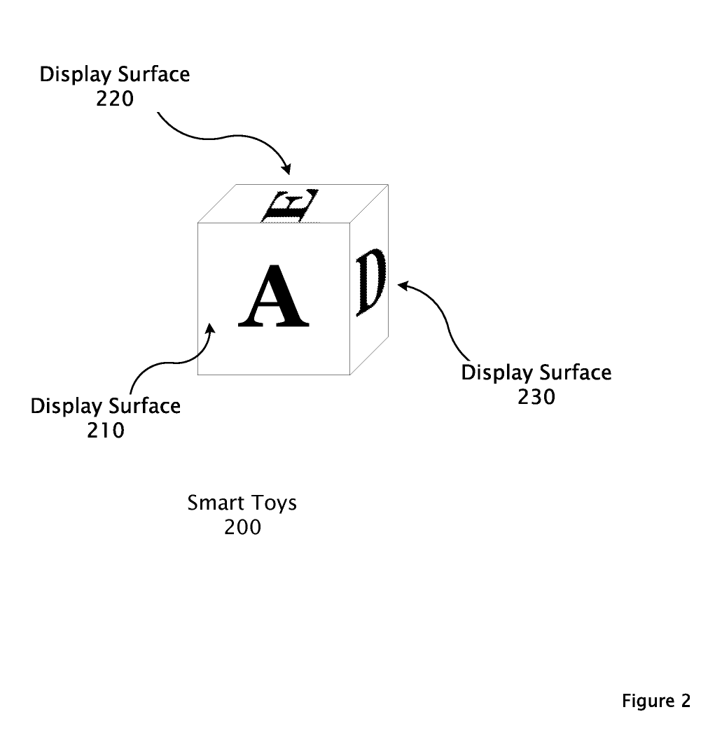

FIG. 2 illustrates Smart Toys 200, according to another embodiment. Smart Toys 200 may have a Display Surface 210, 220, 230, for example, an LED screen or touch screen, which may display letters, numbers, symbols, photos, or other graphics. Display Surface 210, 220, 230 may also be a static display, a letter painted on a block, for example. Display Surface 210, 220, 230 may have different symbols displayed. Smart Toys 200 may determine which symbol is displayed on a particular surface, and may interact with a user based on that determination. For example, Smart Toys 200 may recognize an “E” is displayed on a top of a block, and may treat the block as representing an “E,” while the same block may represent an “A” or another symbol if the orientation of the block is changed. Other faces not shown in FIG. 2 may also have Display Surfaces.

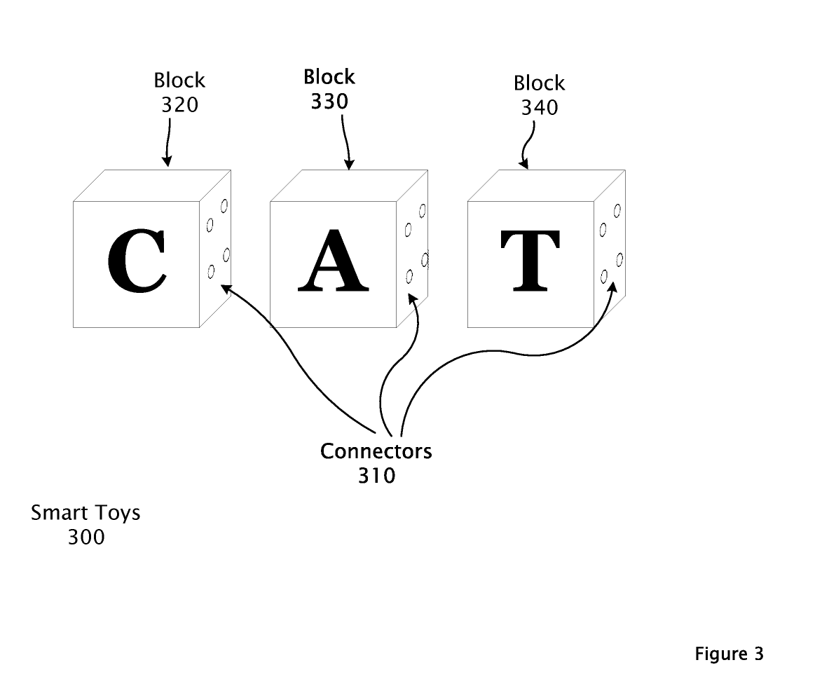

FIG. 3 illustrates Smart Toys 300, according to another embodiment. In this embodiment, Smart Toys 300 may have connectors 310. Connectors 310 may, for example, allow Block 320 to couple mechanically or electrically to Block 330, and Block 330 to couple electrically or mechanically to Block 340. In one embodiment, Connectors 310 may allow Blocks 320, 330, 340 to communicate identity, location, orientation, or other attributes to each other. In another embodiment, Connectors 310 may also connect to other devices mechanically, such as other conventional toys, LEGO®, for example. In another embodiment, attributes of Smart Toys 100 may be recreated in virtual space for other uses. For example, an arrangement of blocks may be relayed to a computer, or the user may design an arrangement virtually and use the design instructions to lay out the blocks.

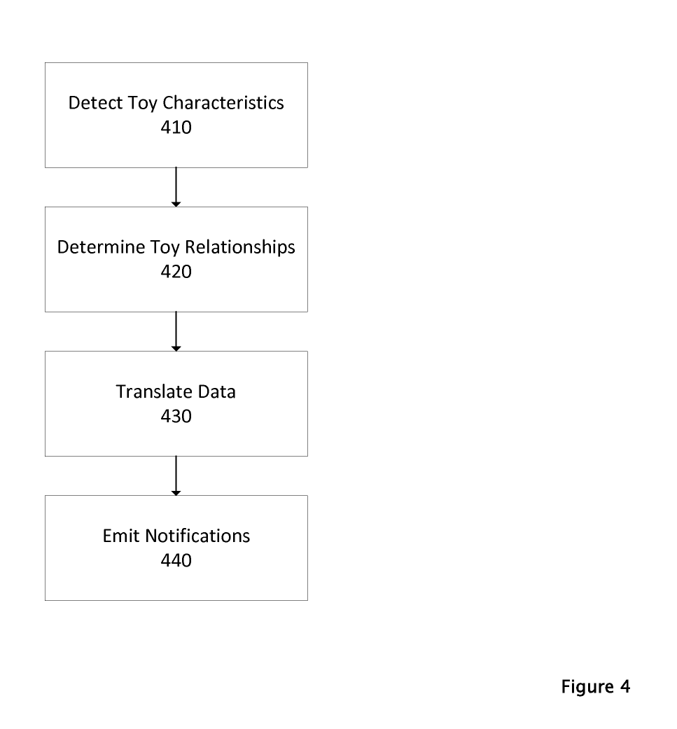

FIG. 4 illustrates a Smart Toys process, according to one embodiment. At Detect Toy Characteristics 410, Smart Toys may determine a toy's position, orientation, weight, or other characteristics, for example, or what letter, number or graphic is shown on a Smart Toys display screen. A user may also assign a property to a toy, and the toy may act according to that property. For example, the user may tell a toy to be a multiplication sign. The toy may display this on its screen, and the toy may function to this effect in a mathematical equation. At Determine Toy Relationships 420, Smart Toys may determine how a toy relates to at least one other toy. For example, it may search a dictionary to determine whether a letter combination on a plurality of Smart Toys may be likely to spell a common word. At Determine Toy Relationships 420, Smart Toys may also find spatial relationships or distances between toys, or determine a sum of a number of dots facing up on a pair of Smart Toys dice, for example, or other relationships. At Translate Data 430, Smart Toys may translate data collected during the steps of Detect Toy Characteristics 410 and Determine Toy Relationships 420 into a format understandable to a user; for example, it may translate data points collected from Smart Toys 100 alphabet blocks into words. Smart Toys may also translate information into different languages, transcribe musical notes, or convert measurements, for example, at Translate Data 430. Additionally, in various forms, Smart Toys may transmit higher, lower, faster or slower pitch in conjunction with a song or other sounds, for example. At Emit Notifications 440, Smart Toys may emit visual or audio notifications regarding how the toys relate. For example, it may recite a word formed by a combination of alphabet blocks placed adjacent to one another, or it may recite the answer to a mathematical equation provided when a user placed toys containing numbers and symbols in close proximity to one another. Smart Toys may also recite the total weight of a group of toys, or it may display a blended color based on individual colors of Smart Toys brought in close proximity to each other, for example.

In addition to visual and audio information, Smart Toys 100 may provide tactile information; for example, it may be configured to produce textured notifications in Braille or another writing system, or to emit vibrations or various levels of heat, cold, moisture, smells, for example.

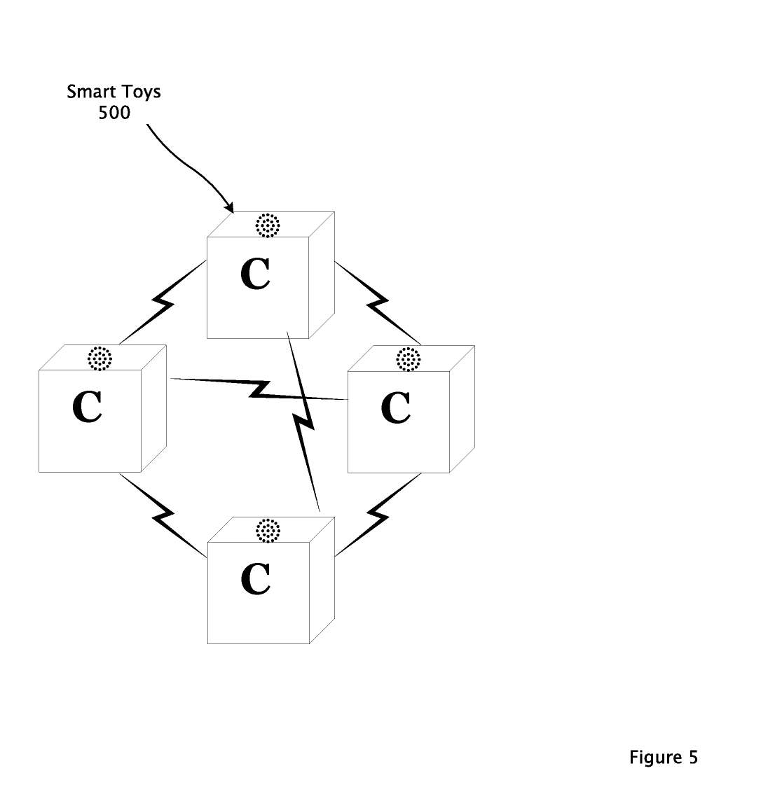

FIG. 5 is a block diagram illustrating an example of a system capable of supporting Smart Toys 500, according to one embodiment. In this example, Smart Toys 500 may be in a networking arrangement configured to communicate with each other. The network may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, the network may include Ethernet connectivity. In another embodiment, the network may include fiber optic connections.

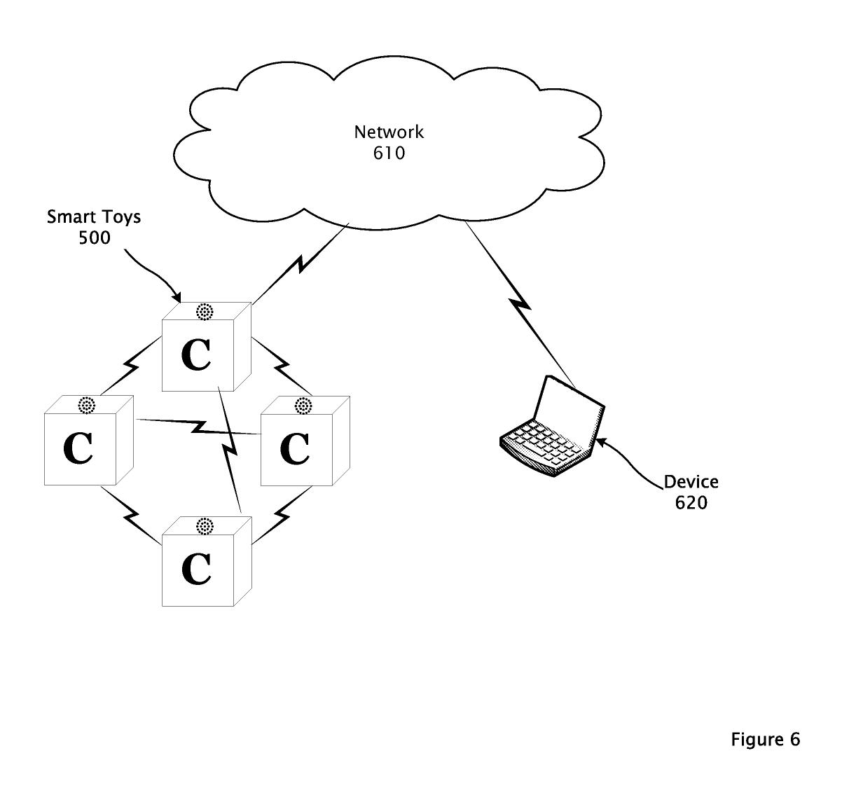

FIG. 6 is a block diagram illustrating an example of a system capable of supporting Smart Toys 500, according to one embodiment. In this example, Smart Toys 500 may be in a networking arrangement configured to communicate with each other. Smart Toys 500 may also communicate with Device 620.

User Device 620 may be used, for example, to configure Smart Toys 500. Smart Toys 500 may allow custom sounds, recorded messages, or other audio to be stored and played back at a later time. Smart Toys 500 may also allow configuration of faces to be programmed. In another embodiment, Smart Toys 500 may communicate with Device 620, reporting movement, geo-spatial configuration, or other information that may allow dynamic updating of Smart Toys 500 to, for example, suit the level of a person using them, or to change the functionality of Smart Toys 500. In yet another embodiment, Smart Toys 500 may report to Device 620 to monitor the progress of a user, allowing the educational experience to be evaluated and optimized, for example.

Network 610 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, the network may include Ethernet connectivity. In another embodiment, the network may include fiber optic connections.

User Device 620 may be a smartphone, tablet, desktop computer, laptop computer, smart watch or intelligent eyewear, or other device, and may have network capabilities to communicate with Server 630. Server 630 may include one or more computers, and may serve a number of roles. Server 630 may be conventionally constructed or may be of a special purpose design for processing data obtained from Smart Toys 500. One skilled in the art will recognize that Server 630 may be of many different designs and may have different capabilities.

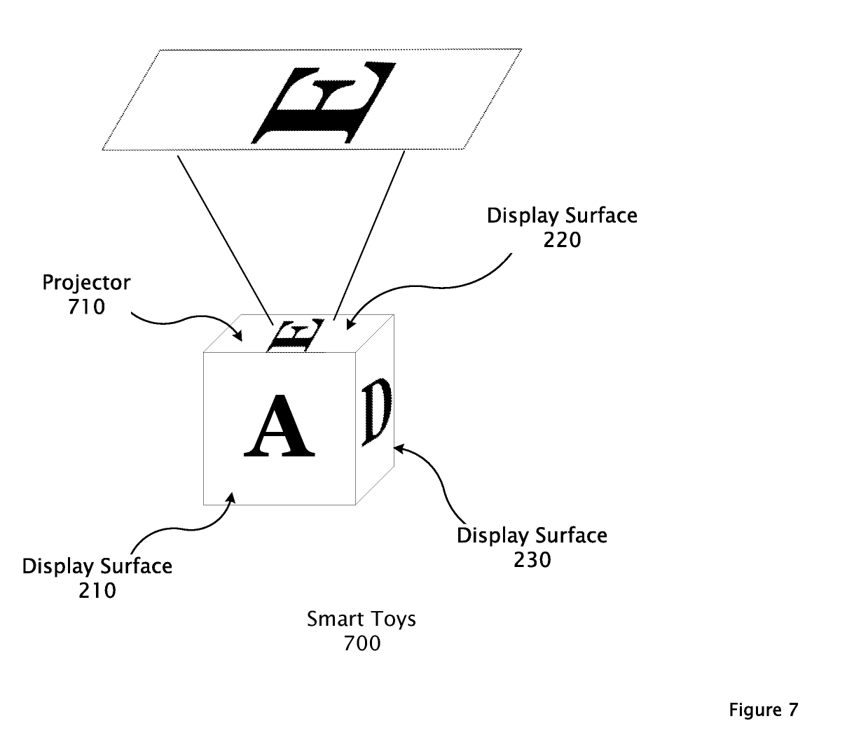

FIG. 7 illustrates Smart Toys 700, according to another embodiment. Smart Toys 700 may include Projector 710, allowing what is displayed on Display Surface 210, 220, or 230 to be projected. Smart Toys 700 may have a Projector 710 capable of projecting each Display Surface 210, 220, 230, or projecting a particular Display Surface 210, 220, or 230. Other faces not shown in FIG. 7 may also have Display Surfaces, which may be projected. Projector 710 may be configured, for example, to project a Display Surface oriented at a top of Smart Toys 700. In another embodiment, Smart Toys 700 may have a projector configured to project multiple Display Surfaces simultaneously. One having skill in the art will recognize that various configurations may be used for projecting Display Surfaces.

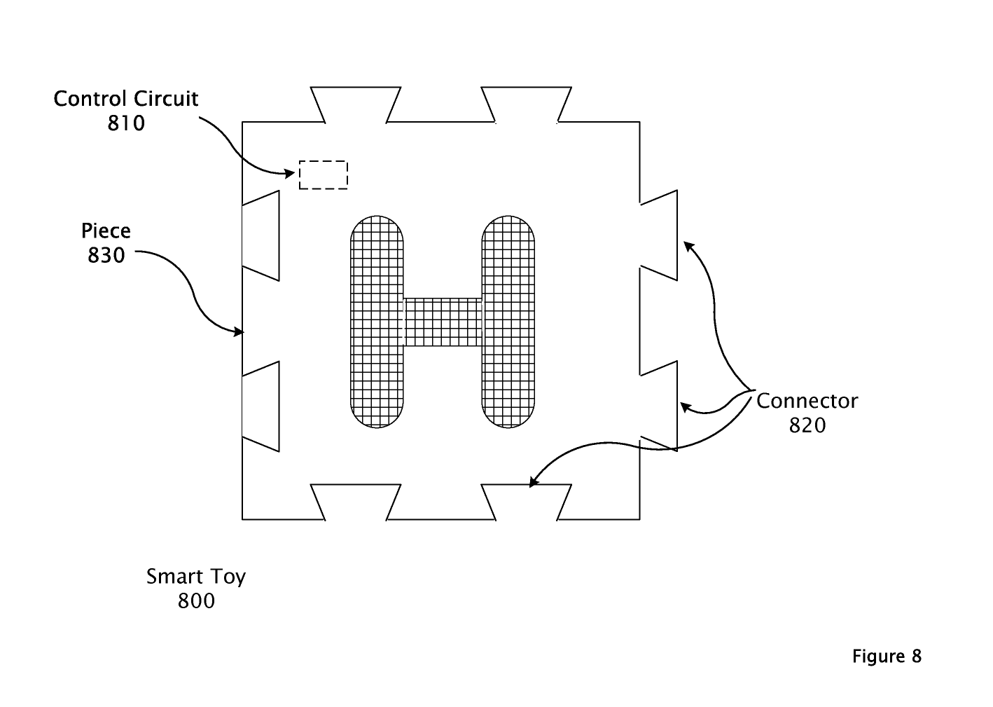

FIG. 8 illustrates Smart Toy 800, according to another embodiment. In this embodiment, Smart Toy 800 may be fairly flat, and may be configured to step on. Smart Toy 800 may also be flexible. Smart Toy 800 may have flexible Control Circuit 810 embedded. Control Circuit 810 may allow Smart Toy 800 to provide audio, visual, tactile, or other notification based on various inputs. For example, if a user steps on or hits Smart Toy 800, a sound may be generated. The sound may be a beep, or it may pronounce a letter, for example. A plurality of Smart Toy 800 may be connected using Connector 820, which may be interlocked like puzzle pieces as illustrated in this example, or may use hooks, hook and loop fasteners, or other ways of attaching. Connector 820 may also include an electrical connection, which may allow Smart Toy 800 to couple and interact with other Smart Toy 800. For example, Smart Toy 800 with various letters or other symbols may be connected to may form words, equations, or other sets of symbols, and may pronounce words spelled out, for example.

In one embodiment, Connector 820 may allow a plurality of Smart Toys 800 to communicate identity, location, orientation, or other attributes to each other. In another embodiment, attributes of Smart Toy 800 may be recreated in virtual space for other uses. For example, an arrangement of a plurality Smart Toys 800 may be relayed to a computer, or the user may design an arrangement virtually and use the design instructions to lay out the blocks.

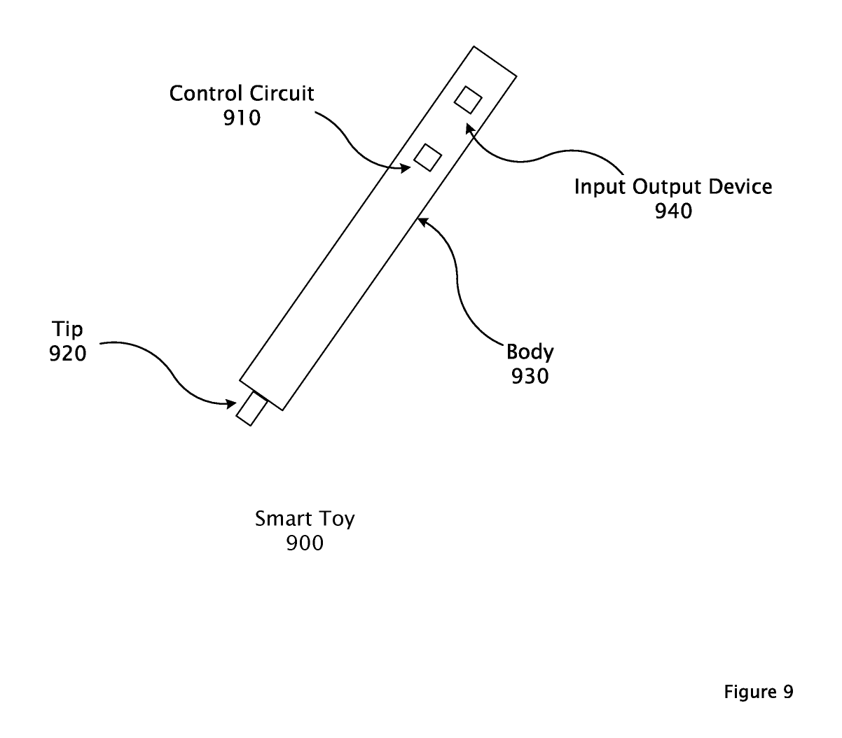

FIG. 9 illustrates Smart Toy 900, according to another embodiment. Smart Toy 900 may take the form of a pen or marker. Tip 920 may be used for marking on paper with ink, for example, or may act as a nib for a stylus on a tablet or other device. Different colors may be selectable, or multiple Smart Toys 900 may have different colors or patterns that get written or transferred when used. For example, Input Output Device 940 may provide an interface allowing selection of colors or operational modes of Smart Toy 900. Interacting with Body 930, such as shaking or squeezing, may cause Control Circuit 910 to output on Input-Output Device 940 an audio, visual, or tactile indicator of a characteristic of the current selection. For example, an audio output saying the color may be provided.

In another embodiment, Smart Toy 900 may recognize words written using Tip 900, and may read them audibly through Input Output Device 940. In yet another embodiment, Smart Toy 900 may have network capabilities to communicate with another device, which may record, display, or print words or figures written or drawn.

One having skill in the art will recognize that various ways of interacting with Smart Toy 900 may be implemented.

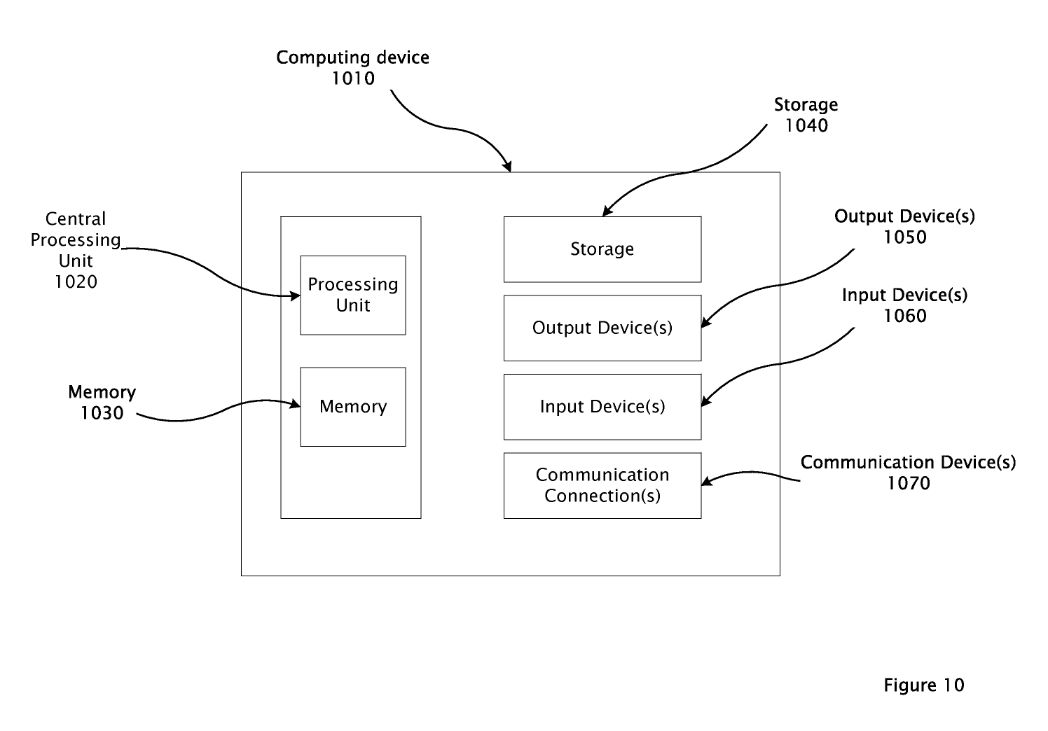

FIG. 10 is a component diagram of a computing device to which a Smart Toys process may be applied according to one embodiment. The Computing Device 1010 can be utilized to implement one or more computing devices, computer processes, or software modules described herein, including, for example, but not limited to a mobile device. In one example, the Computing Device 1010 can be used to process calculations, execute instructions, and receive and transmit digital signals. In another example, the Computing Device 1010 can be utilized to process calculations, execute instructions, receive and transmit digital signals, receive and transmit search queries and hypertext, and compile computer code suitable for a mobile device. The Computing Device 1010 can be any general or special purpose computer now known or to become known capable of performing the steps and/or performing the functions described herein, either in software, hardware, firmware, or a combination thereof.

In its most basic configuration, Computing Device 1010 typically includes at least one Central Processing Unit (CPU) 1020 and Memory 1030. Depending on the exact configuration and type of Computing Device 1010, Memory 1030 may be volatile (such as RAM), non-volatile (such as ROM, flash memory, etc.) or some combination of the two. Additionally, Computing Device 1010 may also have additional features/functionality. For example, Computing Device 1010 may include multiple CPUs. The described methods may be executed in any manner by any processing unit in Computing Device 1010. For example, the described process may be executed by both multiple CPUs in parallel.

Computing Device 1010 may also include additional storage (removable or non-removable) including, but not limited to, magnetic or optical disks or tape. Such additional storage is illustrated in FIG. 10 by Storage 1040. Computer readable storage media include volatile and nonvolatile, removable and non-removable media implemented in any method or technology for storage of information such as computer-readable instructions, data structures, program modules or other data. Memory 1030 and Storage 1040 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 1010. Any such computer-readable storage media may be part of Computing Device 1010. But computer readable storage media do not include transient signals.

Computing Device 1010 may also contain Communications Device(s) 1070 that allow the device to communicate with other devices. Communications Device(s) 1070 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 1010 may also have Input Device(s) 760 such as keyboard, mouse, pen, voice input device, touch input device, etc. Output Device(s) 1050 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions, may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above-described logic and still conform to the described embodiments. Further, operations described herein may occur sequentially, or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A smart toy, comprising:
a housing enclosing:
a processor;
a non-volatile memory operably coupled to the processor;
instructions stored on the non-volatile memory;
a sensor operably coupled to the processor, the sensor providing input to the processor in accordance with the instructions;
an output device operably coupled to the processor, the output device providing output from the processor in accordance with the instructions.

2. The smart toys of claim 1, wherein the internal electronics include at least one device from the list consisting of an accelerometer, a proximity sensor, a motion sensor, an audio sensor, a pressure sensor, a biometric sensor, a barcode scanner, and a QR code scanner.

3. The smart toys of claim 1, further including a device providing a network interface selected from the list containing Wi-Fi, 3G, 4GLTE, Bluetooth, Near Field Communications (NFC).

4. The smart toys of claim 1, wherein the output device comprises an LED screen.

5. A method for a smart toys process, comprising:
detecting a characteristic of a toy;
determining how the toy relates to at least one other toy; and
emitting a notification indicating how the toys relate.

6. Computer readable storage media containing instructions thereon which, when executed by a processor, perform a method comprising:
detecting a characteristic of a toy;
determining how the toy relates to at least one other toy; and
emitting a notification indicating how the toys relate.
